(19) United States
(12) Patent Application Publication
(10) Pub. No.: US 2025/0044539 A1
(43) Pub. Date: Feb. 6, 2025

(54) OPTICAL FIBER CABLE AND OPTICAL FIBER CABLE CONNECTION SYSTEM

(71) Applicant: SUMITOMO ELECTRIC INDUSTRIES, LTD., Osaka (JP)

(72) Inventors: Fumiaki SATO, Osaka (JP); Yuuki SHIMODA, Osaka (JP); Takayuki SHIMAZU, Osaka (JP); Takayuki YOKOCHI, Osaka (JP)

(21) Appl. No.: 18/716,605

(22) PCT Filed: Dec. 10, 2021
(86) PCT No.: PCT/JP2021/045513

§ 371 Date: Jun. 5, 2024

(51) Int. Cl. G02B 6/44

(52) U.S. Cl. CPC G02B 6/4436

(57) ABSTRACT

An optical fiber cable according to an aspect of the present disclosure includes a plurality of optical fibers each of which includes a core portion, a clad portion covering a periphery of the core portion, and a coating portion covering a periphery of the clad portion, and a cable sheath which accommodates the plurality of optical fibers, in which a multi-fiber connector capable of connecting the plurality of optical fibers with 24 or more fibers is arranged at one end of the plurality of optical fibers, and a density of the plurality of optical fibers in the optical fiber cable is 6.5 fibers/mm² or more and 9.0 fibers/mm² or less.

### TECHNICAL FIELD

The present disclosure relates to an optical fiber cable and an optical fiber cable connection system.

### BACKGROUND ART

Patent Literature 1 discloses a multi-fiber optical fiber cable in which a plurality of optical fiber ribbons are densely assembled and integrated.

### CITATION LIST

### Patent Literature

Patent Literature 1: JP2004-161499A

### SUMMARY OF INVENTION

### Solution to Problem

An optical fiber cable according to an aspect of the present disclosure includes:
a plurality of optical fibers each of which includes a core portion, a clad portion covering a periphery of the core portion, and a coating portion covering a periphery of the clad portion; and
a cable sheath which accommodates the plurality of optical fibers, in which
a multi-fiber connector capable of connecting the plurality of optical fibers with 24 or more fibers is arranged at one end of the plurality of optical fibers, and
a density of the plurality of optical fibers in the optical fiber cable is 6.5 fibers/mm² or more and 9.0 fibers/mm² or less.

An optical fiber cable connection system according to an aspect of the present disclosure connects the above optical fiber cable with an indoor optical fiber cable having a multi-fiber connector with 24 or more fibers at one end, and
the connection portion between the optical fiber cable and the indoor optical fiber cable is covered by a junction box.

### BRIEF DESCRIPTION OF DRAWINGS

FIG. 1 illustrates an optical fiber cable according to a first embodiment.

FIG. 2 is a cross-sectional view at the II-II line of FIG. 1.

FIG. 3 is a cross-sectional view of an optical fiber.

FIG. 4 illustrates a multi-fiber connector of an optical fiber cable.

FIG. 5 is a cross-sectional view of the cable body of the optical fiber cable according to a second embodiment.

FIG. 6 is a schematic diagram illustrating an optical fiber cable connection system.

### DESCRIPTION OF EMBODIMENTS

### Problem to be Solved by Present Disclosure

Optical fiber cables such as ultra-multifiber cables were laid by towing and connected to indoor cables by fusion splicing after laying. The problem with towing and fusion splicing is that it takes time to wind the optical fiber cable in a shape of a figure eight, and the connection process takes a long time.

To shorten the laying time, laying by pneumatic pressure feeding is considered as a possible solution. However, there was room for further improvement in order to send the multi-fiber cable by pneumatic pressure feeding and shorten the connection work time.

### Advantageous Effects of Disclosure

The purpose of the present disclosure is to provide a multi-fiber optical fiber cable with improved workability.

### DESCRIPTION OF EMBODIMENTS OF PRESENT DISCLOSURE

First, embodiments of the present disclosure will be listed and described.

(1) An optical fiber cable according to an aspect of the present disclosure includes:
a plurality of optical fibers each of which includes a core portion, a clad portion covering a periphery of the core portion, and a coating portion covering a periphery of the clad portion; and
a cable sheath which accommodates the plurality of optical fibers, in which
a multi-fiber connector capable of connecting the plurality of optical fibers with 24 or more fibers is arranged at one end of the plurality of optical fibers, and
a density of the plurality of optical fibers in the optical fiber cable is 6.5 fibers/mm² or more and 9.0 fibers/mm² or less. Herein, fibers/mm² refers to the number of optical fibers per square millimeter of cross section of optical fiber cable.

Since the optical fiber cable includes the optical fibers at a high density as in the above configuration, the optical fiber cable can be made thinner. Therefore, since the optical fiber cable can be made lightweight, it is easy to lay by pneumatic pressure feeding. This allows the optical fiber cable to be lightweight, which facilitates laying by pneumatic pressure feeding. In addition, since the connectors are provided in advance, fusion splicing work is not required, thereby reducing the connection work time. In addition, since the connector are pre-installed, fusion splicing is not required, thus reducing the connection time.

(2) The plurality of optical fibers of 1728 fibers or more may be accommodated inside the cable sheath.

According to the above configuration, it is possible to lay optical fiber cable containing 1728 or more optical fibers, so-called ultra-multifiber cable, by pneumatic pressure feeding.

(3) An outer diameter of the plurality of optical fibers may be less than 200 μm.

According to the above configuration, since the outer diameter of the optical fibers is less than 200 μm, it is easy to reduce of the diameter of the optical fiber cable.

(4) A fluctuation range of an outer diameter of the clad portion may be ±0.5 μm or less.

According to the optical fiber cable having the above configuration, the clad portion is manufactured so that the fluctuation range of the outer diameter of the clad portion is within a certain range, thereby reducing transmission loss that occurs when connecting the optical fiber cable with the multi-fiber connector.

(5) Silicone may be added to the cable sheath.

According to the optical fiber cable having the above configuration, the addition of silicone to the cable sheath lowers the coefficient of friction of the cable sheath against a pneumatic pressure feeding duct. Therefore, the optical fiber cable with a longer distance over which pneumatic pressure feeding can be performed during laying can be realized.

(6) Inside the cable sheath, the plurality of optical fibers may be bundled into a plurality of subunits, and
outer circumferences of the plurality of subunits may be coated with a subunit coating portion containing a flame retardant material.

According to the optical fiber cable having the above configuration, the plurality of subunit coating portions formed inside the optical fiber cable each contain a flame-retardant material. Therefore, it is possible, for example, to take out the optical fibers from the optical fiber cable outdoor in subunit and lay it on each floor, even for wiring in buildings where higher flame resistance is required. In this way, it becomes easy to handle the optical fiber cable when laying it.

(7) A coating thickness of the subunit coating portion may be between 0.05 mm and 0.5 mm.

If the coating thickness of the subunit coating portion is too thin, the optical fiber inside cannot be effectively protected, and if the coating thickness of the subunit coating portion is too thick, the overall diameter reduction of the optical fiber cable required for pneumatic pressure feeding cannot be achieved. However, with the above coating thickness of the subunit coating portion, both the protection of the optical fiber and the reduction of the overall diameter of the optical fiber cable can be achieved.

(8) The coating portion of the plurality of optical fibers forming the subunit may contain a flame retardant material.

According to the optical fiber cable having the above configuration, the coating portion of the optical fibers inside the subunit coating portion also contains a flame retardant material, thereby improving the flame resistance of the entire optical fiber cable.

(9) A protection tube accommodating the multi-fiber connector may be provided at the end of the optical fiber cable, and
an outer diameter of the protection tube may be less than the outer diameter of the optical fiber cable excluding the protection tube +2 mm.

According to the optical fiber cable having the above configuration, the entire optical fiber cable can be made sufficiently thin, even when the protection tube is provided at the end of the multi-fiber connector.

(10) The number of the plurality of optical fibers that can be connected by the multi-fiber connector may be 96 fibers or more.

According to the optical fiber cable having the above configuration, by increasing the number of optical fibers that can be connected by the multi-fiber connector, the number of required multi-fiber connectors is reduced, and thus the overall diameter of the optical fiber cable can be reduced.

(11) An optical fiber cable connection system according to an aspect of the present disclosure connects an optical fiber cable as described in any one of (1) to (10) above with an indoor optical fiber cable having a multi-fiber connector with 24 or more fibers at one end, in which
a connection portion between the optical fiber cable and the indoor optical fiber cable is covered by a junction box.

According to the optical fiber cable connection system having the above configuration, the optical fiber cable drawn in from outdoors and the indoor optical fiber cable can be easily connected by means of the multi-fiber connector. In addition, since the connection portion is covered by the junction box, it is easy to protect the connection portion effectively.

### DETAILS OF EMBODIMENTS OF PRESENT DISCLOSURE

A specific example of an optical fiber cable according to an embodiment of the present disclosure will be described below with reference to the drawings. Noted that the present disclosure is not limited to the following examples, but is indicated by the claims, and is intended to include all changes within the meaning and scope equivalent to the claims.

### First Embodiment

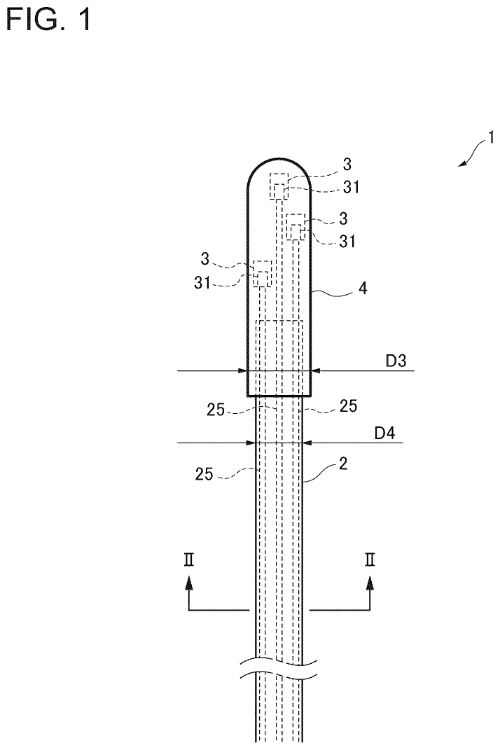

With reference to FIG. 1, optical fiber cable 1 according to a first embodiment will be described.

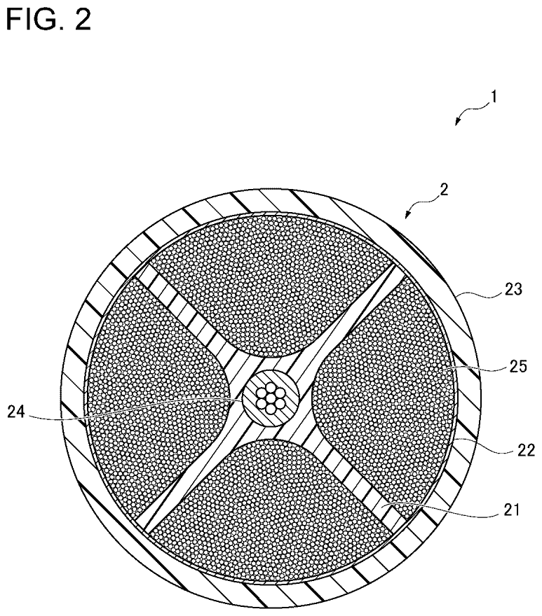

FIG. 1 illustrates an optical fiber cable 1 according to a first embodiment. FIG. 2 is a cross-sectional view at the II-II line of FIG. 1. As shown in FIG. 1, the optical fiber cable 1 includes a cable body 2 and a multi-fiber connector 3. The optical fiber cable 1 according to the present embodiment is an optical fiber cable that is laid by pneumatic pressure feeding.

The multi-fiber connector 3 is, for example, a connector with an MT connector as its base structure. In FIG. 1, only three multi-fiber connectors 3 are shown for convenience of illustration, but the number of multi-fiber connectors 3 may be determined according to the number of optical fibers 25 accommodated by the optical fiber cable 1. The multi-fiber connectors 3 are configured so that at least 24 or more optical fibers 25 can be connected to one multi-fiber connector 3. The multi-fiber connector 3 has, for example, a plurality of ferrules 31 therein. The ferrule 31 is, for example, an MT ferrule in a configuration in which the tip of a plurality of optical fibers 25 is interpolated and fixed.

As shown in FIG. 2, the cable body 2 has a slot rod 21, a hold-down winding tape 22, a cable sheath 23, and a tension member 24. The slot rod 21 has a plurality of slot grooves. The slot grooves are provided in a spiral or SZ twisted shape with respect to the longitudinal direction of the cable body 2.

Each slot groove accommodates a plurality of optical fibers 25, which are rounded from a parallel state to a dense state, respectively. The optical fiber 25 may be accommodated in the slot grooves as an optical fiber ribbon comprising a plurality of optical fibers 25 connected in parallel in a direction orthogonal to the longitudinal direction.

A press-winding tape 22 is wound around the slot rod 21. The press-winding tape 22 is wound around the slot rod 21 and the entire optical fiber 25 in a longitudinal or spiral manner. The tape 22 is processed to absorb water by adhering water-absorbent powder to a base fabric made of polyester or the like. Although the cable body 2 of this embodiment is provided with the press-winding tape 22, the cable body 2 does not necessarily have to be provided with the press-winding tape 22.

The cable sheath 23 covers the perimeter of the hold-down winding tape 22. In other words, the press-winding tape 22 and the optical fiber 25 are housed in the space inside the cable sheath 23. When the diameter of the cable body 2 is 22 mm, the thickness of the cable sheath 23 should be 1.5 mm.

As described above, the optical fiber 25 is accommodated in the space inside the cable sheath 23. The density of the accommodated optical fiber 25 is between 6.5 fibers/mm² and 9.0 fibers/mm². When the density of the optical fiber 25 is 6.5 fibers/mm² or more, the ratio of the area occupied by the optical fiber 25 in the optical fiber cable 1 increases.

The density of the optical fiber 25 is the value obtained by multiplying the number of the optical fiber 25 accommodated in the optical fiber cable 1 by the cable cross-sectional area (cross-sectional area obtained from the diameter of the cable body 2).

In the case of 6.5 fibers/mm² or more, the optical fiber 25 can be accommodated in a smaller space compared to the case of 6.5 fibers/mm² or less, even when accommodating the same number of the optical fibers 25. This makes it possible to reduce the diameter of the optical fiber cable 1. Furthermore, the overall weight of the optical fiber cable 1 can also be reduced because the smaller diameter allows the volume of the slot rod 21 and the cable sheath 23 provided around the slot rod 21 to be reduced.

If the density of the optical fibers 25 which are accommodated becomes too large, the transmission loss of the entire optical fiber cable 1 may increase. Therefore, it is desirable that the density of the optical fibers 25 accommodated be 9.0 fibers/mm² or less.

In this embodiment, by providing optical fibers 25 at a high density as described above, the optical fiber cable 1 can be made thinner and lighter. This facilitates laying of the cable by pneumatic pressure feeding. In addition, since connectors are provided in advance, fusion splicing work is not required when connection optical fiber cables 1 to 1, thus reducing the connection work time.

In the cable body 2, the optical fibers 25 housed inside the cable sheath 23 may be 1728 fibers or more. By configuring the cable as described above, even a so-called super multi-fiber cable with many optical fibers 25 inside, such as the optical fiber cable 1 of this embodiment, it is possible to lay the cable by pneumatic pressure feeding.

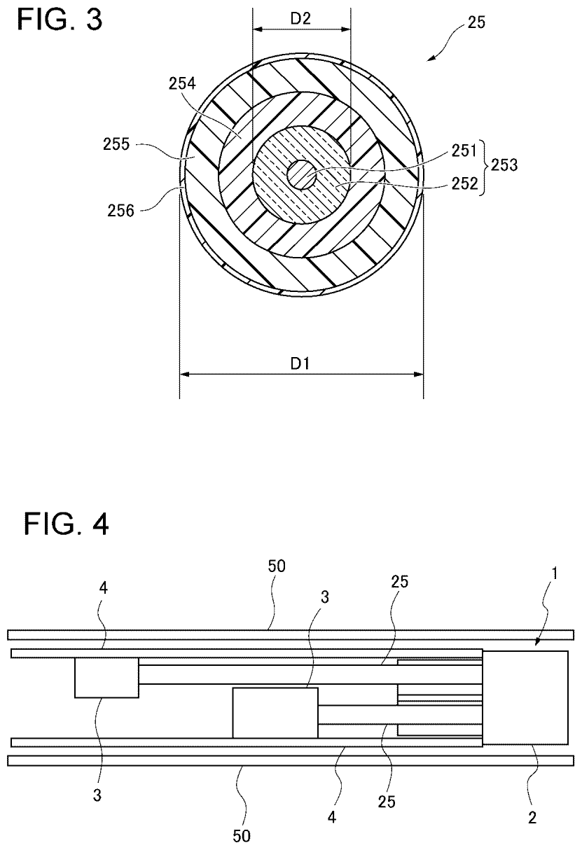

Next, the optical fibers 25 accommodated inside the slot grooves will be described. FIG. 3 shows a cross-sectional view of the optical fiber 25. As shown in FIG. 3, the optical fiber 25 has a glass fiber 253 consisting of a core portion 251 having a higher refractive index than the surrounding glass and a clad portion 252 surrounding the core portion 251, coating portions 254, 255 as a two-layer covering the periphery of the glass fiber 253, and a coloring layer 256 covering the periphery of the coating portion 255. The inner coating portion 254 of the coating portions 254, 255 as the two-layer is formed of a cured primary resin. The outer coating portion 255 of the coating portions 254, 255 as the two-layer is formed of a cured secondary resin.

The glass fiber 253 has a core portion 251 at its center and a clad portion 252 covering the periphery of the core portion 251.

A soft resin with a relatively low Young's modulus is used as a buffer layer in the primary resin that constitutes the inner primary coating section in contact with the glass fiber 253. The secondary resin that makes up the outer secondary coating section is made of a hard resin with a higher Young's modulus than the primary resin as a protective layer. The Young's modulus of the cured material of the primary resin is 1.0 MPa or less at room temperature (e.g., 23° C.), and preferably 0.7 MPa or less. The Young's modulus of the cured material of the secondary resin is 900 MPa or more at room temperature (e.g., 23° C.), preferably 1000 MPa or more, and even more preferably 1500 MPa or more.

Here, the diameter D1 of the optical fiber 25 should be less than 200 μm. By determining the diameter D1 of the optical fiber 25 as above, it becomes easier to reduce the diameter of the optical fiber cable 1.

The variation range of the outer diameter D2 of the clad portion 252 should be produced within a certain range. Specifically, the variation range of the outer diameter D2 of the clad portion 252 should be ±0.5 μm or less. By manufacturing the clad portion 252 as described above, the fluctuation width of the outer diameter D2 of the clad portion 252 is manufactured so that it falls within a certain range, thereby reducing the transmission loss that occurs when the optical fiber cables 1 are connected by the multi-fiber connector 3.

In the optical fiber cable 1, silicone may be added to the cable sheath 23. In this case, the coefficient of friction of the cable sheath 23 against the duct for pneumatic feeding is reduced. As a result, the frictional force generated when the cable sheath 23 and the pneumatic feeding duct 50 (see FIG. 4) rub against each other is reduced, and thus an optical fiber cable 1 that can pneumatically feed a long distance during laying can be realized.

In the optical fiber cable 1 of this embodiment, the number of the optical fibers 25 that the multi-fiber connector 3 can connect should be 96 fibers or more. The higher the number of the optical fibers 25 that the multi-fiber connector 3 can connect, the fewer the number of multi-fiber connectors 3 required, and thus the easier it is to connect the optical fiber cable 1.

Returning to FIG. 1, the optical fiber cable 1 of this embodiment further has a protection tube 4. The protection tube 4 is, for example, a metal member. The protection tube 4 is provided at the end of the optical fiber cable 1 and accommodates the multi-fiber connector 3 therein. The protection tube 4 protects the end of the cable body 2 and the multi-fiber connector 3 from damage during pneumatic feeding.

As shown in FIG. 1, the outer diameter D3 of the protection tube 4 is slightly larger than the outer diameter of the optical fiber cable 1 excluding the protection tube 4. In the optical fiber cable 1 of this embodiment, the “outer diameter of the optical fiber cable 1 excluding the protection tube 4” corresponds to the outer diameter D4 of the cable body 2. The outer diameter D3 of the protection tube 4 should be larger than the outer diameter D4 of the cable body 2 and smaller than the outer diameter D4+2 mm.

Thus, in the optical fiber cable 1 of this embodiment, the size of the outer diameter D3 of the protection tube 4 is kept within a certain range larger than the outer diameter of the optical fiber cable 1 excluding the protection tube 4. As a result, even when the protection tube 4 is provided to protect the multi-fiber connector 3, etc., the entire optical fiber cable 1 can be made sufficiently thin.

Next, the multi-fiber connector 3 of the optical fiber cable 1 will be explained. FIG. 4 illustrates the multi-fiber connector 3 of the optical fiber cable 1. FIG. 4 illustrates the case where a protection tube 4 is provided at the end of the optical fiber cable 1.

The optical fiber cable 1 is inserted in the pneumatic feeding duct 50 at the time of laying. The inner diameter of the pneumatic feeding duct 50 is, for example, 28 mm. The outer diameter of the cable body 2 is about 1 mm smaller than the outer diameter of the protection tube 4. For example, in the optical fiber cable 1 of this embodiment, the outer diameter of the cable body 2 is 22 mm and the outer diameter of the protection tube 4 is 23 mm. A multi-fiber connector 3 is provided inside the protection tube 4. A plurality of optical fibers are connected to the multi-fiber connector 3. The multi-fiber connector 3 should have an outer diameter that is approximately half the inner diameter of the protection tube 4. For example, the inner diameter of the protection tube 4 is 19 mm and the outer diameter of the multi-fiber connector is 10 mm. Thus, by making the multi-fiber connector 3 about half the inner diameter of the protection tube 4, it is possible to secure a space for the optical fiber 25 to be connected to another multi-fiber connector 3.

When a plurality of multi-fiber connectors 3 provided inside the protection tube 4 are about half the inner diameter of the protection tube 4, as shown in FIG. 4, the plurality of multi-fiber connectors 3 can be staggered in the longitudinal direction of the optical fiber cable 1, thereby suppressing enlargement of the inner diameter of the protection tube 4.

### Second Embodiment

Next, the optical fiber cable 1A according to the second embodiment will be described. For convenience of explanation, the description of members having the same reference numbers as those already described in the description of the second embodiment will be omitted.

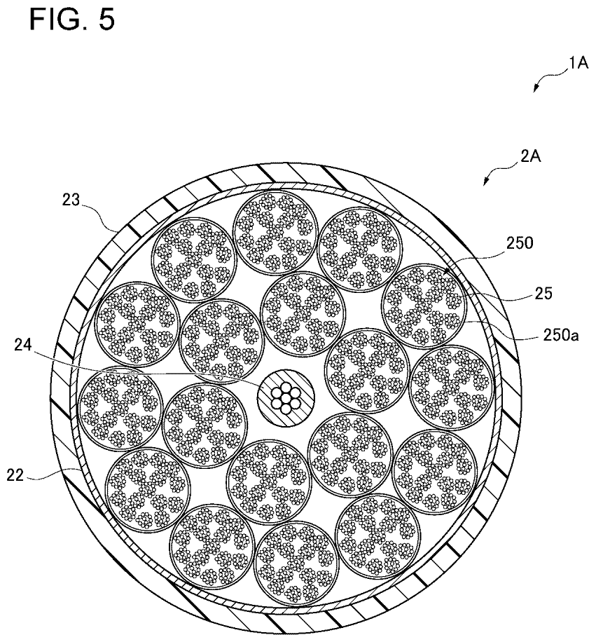

FIG. 5 is a cross-sectional view of the cable body 2A of the optical fiber cable 1A according to the second embodiment. Like the first embodiment, the optical fiber cable 1A of the second embodiment has a cable body 2A and a multi-fiber connector 3 (see FIG. 1 and FIG. 4) common to the first embodiment. However, compared to the first embodiment, the internal structure of the cable body 2A is different. More specifically, in the space inside the cable sheath, slot rods 21 are not provided, and a plurality of optical fibers 25 are bundled together for each of a plurality of subunits 250.

Each of the subunits 250 is covered by a subunit covering 250a. By tearing the cable sheath 23, the cable is configured to allow wiring to each of the subunits 250 covered by the subunit sheath 250a.

The subunit sheath 250a is formed containing a flame retardant material. An example of a subunit coating portion 250a formed including a flame-retardant material is, for example, a coating of the subunit 250 with a flame-retardant polyolefin.

In general, optical fiber cables used indoors require higher flame resistance than those used outdoors. For this reason, optical fiber cables with different flame retardance are used for indoor and outdoor use. Normally, when an optical fiber cable for outdoor use with low flame retardance is drawn into an indoor area, it is necessary to connect it with an indoor cable with high flame retardance before it is put into the indoor area.

In the optical fiber cable 1A of this embodiment, the plurality of subunit coating portions 250a formed inside the cable are each configured to include a flame-retardant material. This makes it possible to take out the optical fiber 25 from the outdoor cable for each of the 250 subunits and lay them on each floor, even for wiring in a building, for example, where higher flame resistance is required. In this way, it becomes easy to handle the optical fiber cable 1A when laying it out.

The coating thickness of the subunit coating section 250A should be between 0.05 mm and 0.5 mm. If the coating thickness of the subunit coating section 250a is too thin, the optical fiber inside cannot be effectively protected, and if the coating thickness of the subunit coating section 250a is too thick, the overall diameter reduction of the optical fiber cable required for pneumatic feeding cannot be achieved. If the coating thickness of the subunit coating 250a is as described above, it is possible to both protect the optical fiber 25 and reduce the overall diameter of the optical fiber cable 1A.

In the plurality of optical fibers 25 comprising the subunit 250, the coating portions 254, 255 should contain a flame retardant material. Since not only the subunit coating 250a but also the coating portions 254, 255 of the optical fibers 25 inside the subunit 250a contain flame retardant material, the flame resistance of the optical fiber cable 1A as a whole is improved.

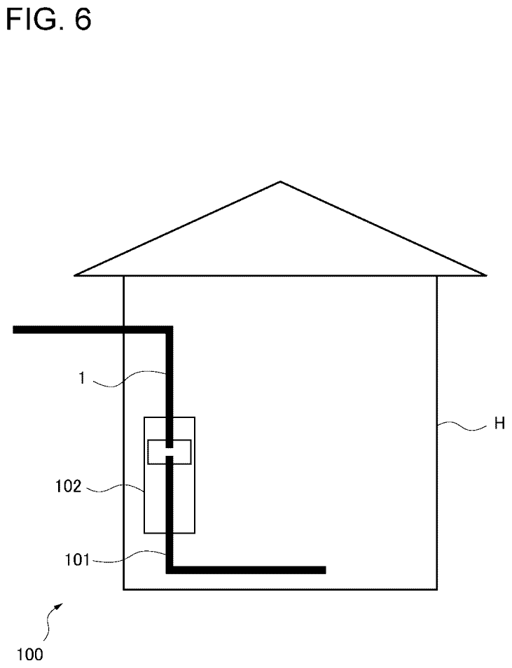

Next, an optical fiber cable connection system 100 using the optical fiber cables 1, 1A of the first and second embodiments will be described. FIG. 6 is a schematic diagram illustrating the optical fiber cable connection system 100. As shown in FIG. 6, the optical fiber cable connection system 100 has an optical fiber cable 1 according to the first embodiment that is drawn into a building H from outside the building H and an optical fiber cable 101 for indoor use. The optical fiber cable 101 for indoor use is equipped with a multi-fiber connector (not shown) with 24 or more fibers at least at one end thereof. The optical fiber cable 1 and the indoor optical fiber cable 101 can be connected by the multi-fiber connector 3 provided by the optical fiber cable 1 and the multi-fiber connector provided by the indoor optical fiber cable 101.

The optical fiber cable drawn into the building H from outside the building H may be the optical fiber cable 1A of the second embodiment. In the case of the optical fiber cable 1A, the subunit 250 may be wired as the optical fiber cable 101 for indoor use, without going through the junction box 102.

The optical fiber cable 1 and the indoor optical fiber cable 101 are connected inside the junction box 102. In other words, the connection portion between the optical fiber cable 1 and the indoor optical fiber cable 101 is covered by the junction box 102.

Since the optical fiber cable 1 is equipped with a multi-fiber connector 3, it can be easily connected to the indoor optical fiber cable 101. In addition, since the connection part is covered by the junction box 102, it is easy to effectively protect the connection part.

Although the present disclosure has been described in detail and with reference to specific embodiments, it is clear to those skilled in the art that various changes and modifications can be made without departing from the spirit and scope of the present disclosure. The number, position, shape, etc. of the components described above are not limited to the above embodiments, and can be changed to any number, position, shape, etc. that is suitable for implementing the present disclosure.

### REFERENCE SIGNS LIST

1, 1a: optical fiber cable
2, 2a: cable body
3: multi-fiber connector
4: protection tube
21: slot rod
22: tape
23: cable sheath
24: tension member
25: optical fiber
31: ferrule
50: pneumatic pressure feeding duct
100: optical fiber cable connection system
101: fiber optic cable for indoor use
102: junction box
250: subunit
250a: subunit sheath
251: core portion
252: clad portion
253: glass fiber
254: coating portion
255: coating portion
256: colored layer

What is claimed is:

1. An optical fiber cable comprising:
a plurality of optical fibers each of which includes a core portion, a clad portion covering a periphery of the core portion, and a coating portion covering a periphery of the clad portion; and
a cable sheath which accommodates the plurality of optical fibers,
wherein a multi-fiber connector capable of connecting the plurality of optical fibers with 24 or more fibers is arranged at one end of the plurality of optical fibers, and
wherein a density of the plurality of optical fibers in the optical fiber cable is 6.5 fibers/mm² or more and 9.0 fibers/mm² or less.

2. The optical fiber cable according to claim 1,
wherein the plurality of optical fibers of 1728 fibers or more are accommodated inside the cable sheath.

3. The optical fiber cable according to claim 1,
wherein an outer diameter of the plurality of optical fibers is less than 200 μm.

4. The optical fiber cable according to claim 1,
wherein a fluctuation range of an outer diameter of the clad portion is +0.5 μm or less.

5. The optical fiber cable according to claim 1,
wherein silicone is added to the cable sheath.

6. The optical fiber cable according to claim 1,
wherein inside the cable sheath, the plurality of optical fibers are bundled into a plurality of subunits, and
wherein outer circumferences of the plurality of subunits are coated with a subunit coating portion containing a flame retardant material.

7. The optical fiber cable according to claim 6,
wherein a coating thickness of the subunit coating portion is between 0.05 mm and 0.5 mm.

8. The optical fiber cable according to claim 6,
wherein the coating portion of the plurality of optical fibers forming the subunit contains a flame retardant material.

9. The optical fiber cable according to claim 1,
wherein the number of the plurality of optical fibers that can be connected by the multi-fiber connector are 96 fibers or more.

10. The optical fiber cable according to claim 1,
wherein a protection tube accommodating the multi-fiber connector is provided at the end of the optical fiber cable, and
wherein an outer diameter of the protection tube is less than the outer diameter of the optical fiber cable excluding the protection tube +2 mm.

11. An optical fiber cable connection system which connects an optical fiber cable according to claim 1 with an indoor optical fiber cable having a multi-fiber connector with 24 or more fibers at one end,
wherein a connection portion between the optical fiber cable and the indoor optical fiber cable is covered by a junction box.
